(19) United States
(12) Patent Application Publication
(10) Pub. No.: US 2012/0227718 A1
(43) Pub. Date: Sep. 13, 2012

(54) FLEXIBLE ANTI-CRACK SLIP-SURFACE CERAMIC ENGINE CYLINDER SLEEVE

(76) Inventor: Gyula Kis-Benedek, San Diego, CA (US)

(21) Appl. No.: 13/046,653

(22) Filed: Mar. 11, 2011

(51) Int. Cl. F02B 75/08

(52) U.S. Cl. 123/668

(57) ABSTRACT

An array of ceramic tiles is arranged on a machine bearing surface. A tile matrix is bonded to the ceramic tiles that separates the ceramic tiles from one another on the machine bearing surface by a tile spacing.

### BACKGROUND OF THE INVENTION

1. Field of the Invention

The present invention relates generally to machine bearings for machine parts that slide or rotate against each other, for example, pistons that move inside the cylinders of an internal combustion engine. More specifically, but without limitation thereto, the present invention relates to a ceramic cylinder bearing for internal combustion engines.

2. Description of Related Art

A combustion engine typically includes one or more aluminum pistons with steel piston rings that move at high speeds against a steel cylinder wall. The steel/aluminum interface and the steel/steel interface between the pistons and the cylinder wall must be lubricated with a film of oil to prevent the pistons from seizing against the cylinder. Because the heat from the fuel combustion burns the oil film away, the oil film must be constantly replenished. The burned oil film combines with the exhaust, producing air pollution and high oil consumption.

### SUMMARY OF THE INVENTION

In one embodiment, an array of ceramic tiles is arranged on a machine bearing surface. A tile matrix is bonded to the ceramic tiles that separates the ceramic tiles from one another on the machine bearing surface by a tile spacing.

### BRIEF DESCRIPTION OF THE DRAWINGS

The above and other aspects, features and advantages will become more apparent from the description in conjunction with the following drawings presented by way of example and not limitation, wherein:

FIG. 1 illustrates an internal combustion engine cylinder of the prior art;

FIG. 2 illustrates a ceramic mosaic machine bearing for the engine cylinder of FIG. 1; and

FIG. 3 illustrates a cross sectional view of the ceramic mosaic machine bearing of FIG. 2.

Elements in the figures are illustrated for simplicity and clarity and have not necessarily been drawn to scale. For example, the dimensions of some elements in the figures may be exaggerated relative to other elements, and features of some elements may be omitted in certain views to facilitate illustration and explanation of various embodiments. Accordingly, indicia that reference an element or a combination of elements in any view include by reference all the features shown for that element or combination of elements referenced by the same indicia in all the views.

### DETAILED DESCRIPTION OF THE ILLUSTRATED EMBODIMENTS

The following description is not to be taken in a limiting sense, rather for the purpose of describing by specific examples the general principles that are incorporated into the illustrated embodiments. The terms and expressions used in the description and the claims have the same meanings accorded to such terms and expressions in the corresponding respective areas of inquiry and study, except where other meanings have been given specifically to such terms and expressions in the description.

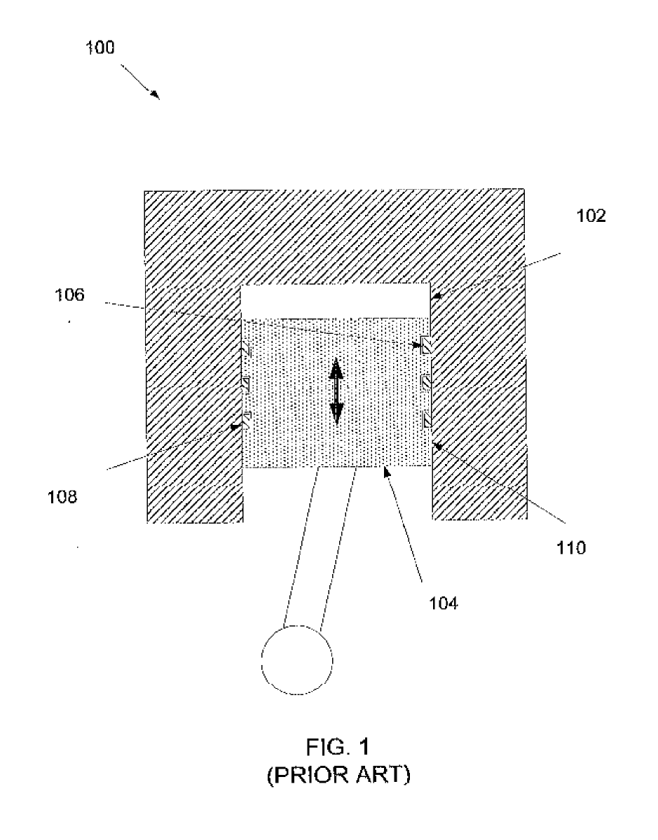

FIG. 1 illustrates an internal combustion engine cylinder 100 of the prior art. Shown in FIG. 1 are a steel cylinder wall 102, an aluminum piston 104, steel piston rings 106, a steel/steel interface 108, and a steel/aluminum interface 110.

In FIG. 1, the cylinder wall 102 is the machine bearing surface for the piston 104 and the piston rings 106. Other examples of machine bearing surfaces include guide rails, tracks, bushings, and other surfaces generally intended to reduce sliding friction or rotating friction in a machine. A machine is defined herein as an apparatus consisting of an assembly of parts made from a design that predicts the movement and the non-movement of each part relative to all of the other parts. For example, a carriage designed to slide on guide rails or tracks would qualify as a machine under this definition. On the other hand, a cardboard box being pushed along a ceramic tile floor would not qualify as a machine under this definition, because the ceramic tile floor was not designed to cooperate with the cardboard box, and because the cardboard box was not deigned to cooperate with the ceramic tile floor. Accordingly, surfaces that are not intended for reducing friction in a machine, for example, ceramic tile floors, ceramic tile walkways, ceramic tile countertops, ceramic tile decorations, and other ceramic tiled surfaces that are not a part of a machine are specifically excluded under the definition of a machine bearing surface in this application and are also specifically excluded from the scope of the appended claims.

Due to the rapid motion of the piston 104 against the cylinder wall 102, the steel/steel interface 108 and the steel/aluminum interface 110 is coated with a film of oil or a similar lubricant to avoid scoring and seizing of the piston 104. During the fuel combustion cycle, the oil film on the cylinder wall 102 is burned away and combines with the fuel exhaust, resulting in air pollution and heavy oil consumption. Also, the burning oil in the engine cylinder 100 reduces the efficiency of the fuel combustion, decreasing engine performance and fuel mileage.

Air pollution may be reduced and oil may be substantially conserved by lining the steel cylinder wall 102 with a ceramic material that does not require oil lubrication. Disadvantageously, typical ceramic cylinder linings expand and contract from thermal cycling inside the engine cylinder 100 until the ceramic fractures. A ceramic machine bearing that can expand and contract with thermal cycling in the internal combustion engine cylinder 100 of FIG. 1 with little or no oil is described as follows.

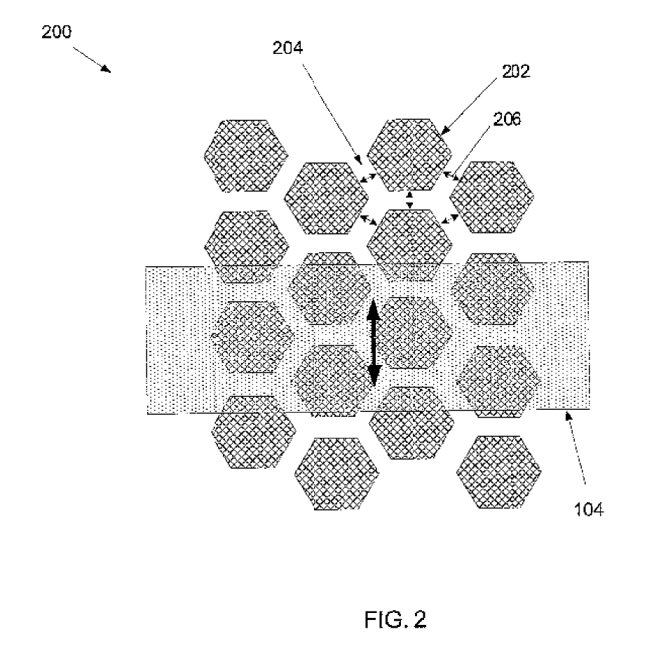

FIG. 2 illustrates a ceramic mosaic machine bearing 200 for the engine cylinder 100 of FIG. 1. Shown in FIG. 2 are an aluminum piston 104, ceramic tiles 202, a tile matrix 204, and a tile spacing 206.

In FIG. 2, the ceramic tiles 202 are arranged on the tile matrix 204. In a preferred embodiment, the tile matrix 204 is made from the same material as the machine bearing surface, for example, the steel cylinder wall 102 in FIG. 1. In other embodiments, the tile matrix 204 is made of various metals, alloys, and other materials used in the manufacture of machine bearings according to well-known techniques to suit specific applications within the scope of the appended claims. In one embodiment, the tile matrix 204 is bonded according to well-known techniques to the ceramic tiles 202 to separate the ceramic tiles 202 from one another on the machine bearing surface by the tile spacing 206.

The ceramic tiles 202 preferably have a geometry that alternates the tile spacing 206 with the ceramic tiles 202 in both the vertical and the horizontal directions as shown in FIG. 2 to ensure that the piston 104 has adequate bearing support inside the cylinder wall 102. In a preferred embodiment, the ceramic tiles 202 have a hexagonal geometry. In other embodiments, the ceramic tiles 202 have a rhombic, octagonal, or other geometry to suit specific applications within the scope of the appended claims. For example, for an engine cylinder having a diameter of 110 mm and a length of 200 mm, a suitable diameter for each of the ceramic tiles 202 is about 6 mm with a tile thickness of about 0.6 mm and a tile spacing 206 of about 1.8 mm.

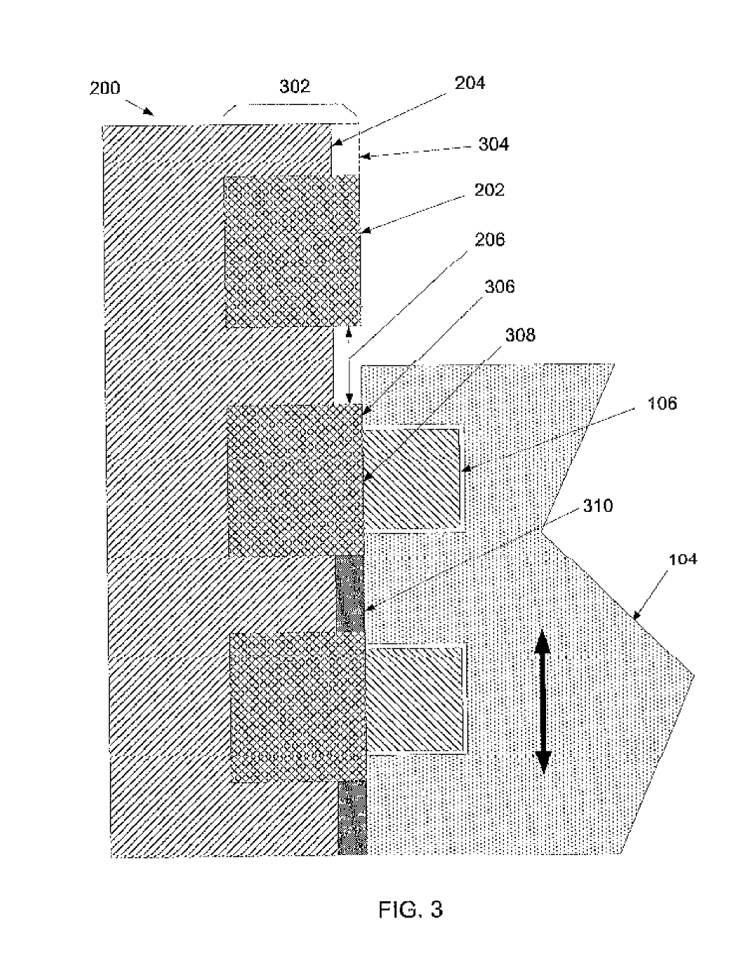

FIG. 3 illustrates a cross sectional view of the ceramic mosaic machine bearing 200 of FIG. 2. Shown in FIG. 3 are an aluminum piston 104, steel piston rings 106, ceramic tiles 202, a tile matrix 204, a tile spacing 206, a tile thickness 302, tile matrix surface before wear 304, a ceramic/aluminum interface 306, a ceramic/steel interface 308, and an oil film 310.

In FIG. 3, the tile matrix 204 is made according to a preferred embodiment by drilling or cutting blind holes into the machine bearing surface. In one embodiment, the machine bearing surface is the steel cylinder wall 102 in FIG. 1. The holes in the tile matrix 204 are made according to well-known techniques in the shape of the ceramic tiles 202, for example, by a small mill or a laser drill to a depth equal to the desired tile thickness 302. Other metals and materials may be used to make the tile matrix 204 according to well-known techniques to suit specific applications within the scope of the appended claims.

The ceramic tiles 202 are made, for example, by coating the machine bearing surface according to well-known techniques with a ceramic, for example, an alumina or a zirconia plasma spray coating that bonds to the cylinder wall 102. The ceramic spray coating is then machined or bored down to or near the tile matrix 204, for example, with a diamond bore. The machined or bored surface of the ceramic coating is then ground or honed, for example, with a diamond hone to form the array of ceramic tiles 202 in the tile matrix 204 separated from one another by the tile spacing 206. The array of ceramic tiles 202 separated from one another by the tile spacing 206 simulates stress relief grooves formed in concrete to avoid cracking in response to thermal cycling.

In operation, the aluminum piston 104 slides against the ceramic mosaic machine bearing 200 formed by the array of ceramic tiles 202 in the tile matrix 204. The tile matrix 204 expands and contracts between the ceramic tiles 202 with temperature in the engine cylinder 100, causing the ceramic tiles 202 to move farther apart and closer together in response to thermal cycling. The expansion and contraction of the tile matrix 204 avoids stress in the ceramic tiles 202 so that fracturing does not occur, even in large engine cylinders. Because the steel bearing surface wears more rapidly than the harder surface of the ceramic tiles 202, the tile matrix 204 recedes slightly away from the original surface of the tile matrix surface 304. As a result, the piston 104 bears against the ceramic mosaic machine bearing 200 at the ceramic/aluminum interface 306, and the piston rings 106 bear against the ceramic mosaic machine hearing 200 at the ceramic/steel interface 308. Because the ceramic tiles 202 repel oil, the ceramic/aluminum interface 306 and the ceramic/steel interface 308 are free of oil. The oil film 310 covering the tile spacing 206 in the tile matrix 204 provides a gas seal that maintains cylinder compression and protects the side of the piston 104 from exposure to corrosive combustion residues.

Because the ceramic/aluminum interface 306 and the ceramic/steel interface 308 are free of oil, only about one-fourth as much oil is consumed in lubricating the piston 104 when the ceramic mosaic machine bearing 200 is included in the engine cylinder 100 of FIG. 1. The reduction in oil consumption substantially reduces air pollution and increases the fuel combustion efficiency. The ceramic tiles 202 also reduce the friction of the piston 104 against the cylinder wall 102, resulting in improved mechanical efficiency and fuel mileage, and the superior hardness of the ceramic tiles 202 results in longer engine life and reduced maintenance costs.

Another advantage of the ceramic mosaic machine bearing 200 is that the ceramic tiles 202 are poor conductors of heat, resulting in a higher cylinder temperature inside the engine cylinder 100. The higher combustion temperature produces more efficient combustion of the air/fuel mixture and also shortens the air/fuel mixture burn time. The shorter air/fuel mixture burn time allows the engine to run at higher rpm while maintaining peak fuel combustion efficiency. The improved fuel combustion efficiency and the reduced oil consumption both act to reduce air pollution from the exhaust and to increase the mechanical efficiency of the engine.

A further advantage of the ceramic mosaic machine bearing 200 is that the higher cylinder temperature results in more complete fuel combustion, minimizing the combustion residues in the cylinder that may otherwise cause corrosion of the piston rings 106. The higher cylinder temperature also increases cylinder compression in diesel engines, reducing the starting time and improving diesel performance in cold weather.

Still another advantage of the ceramic mosaic machine bearing 200 is that the ceramic tiles 202 typically have 10 to 20 times the wear resistance of steel. As a result, distortion of the cylinder wall 102 from circular to oval shape due to side thrust from the piston 104 against the cylinder wall 102 from the crankshaft is avoided, resulting in longer engine life and reduced maintenance costs.

Various embodiments of the ceramic mosaic machine bearing 200 described above may be advantageously applied to any size engine cylinder and may also be implemented in other types of machine bearings according to well-known techniques to suit specific applications within the scope of the following claims. Accordingly, the specific embodiments and applications of the ceramic mosaic machine bearing 200 described above are for illustrative purposes only and do not preclude modifications and variations that are encompassed by the scope of the following claims.

What is claimed is:

1. A machine bearing comprising:
an array of ceramic tiles arranged on a machine bearing surface; and
a tile matrix bonded to the ceramic tiles that separates the ceramic tiles from one another on the machine bearing surface by a tile spacing.

2. The machine bearing of claim 1, the tile matrix made of a material that expands and contracts to move the ceramic tiles closer together and farther apart on the machine bearing surface response to thermal cycling.

3. The machine bearing of claim 2 further comprising the tile matrix made of steel.

4. The machine bearing of claim 1 further comprising each of the ceramic tiles having a hexagonal geometry.

5. The machine bearing of claim 1 further comprising holes formed in the machine bearing surface that hold the ceramic tiles in the tile matrix.

6. The machine bearing of claim 5 further comprising the holes having a depth equal to a tile thickness of the ceramic tiles.

7. The machine bearing of claim 1 further comprising the array of ceramic tiles made from a plasma spray coating.
